(19) United States
(12) Patent Application Publication
(10) Pub. No.: US 2026/0236338 A1
(43) Pub. Date: Aug. 13, 2026

(54) PREEMPTIVE NODE FAULT DETECTION FOR DEEP LEARNING INFRASTRUCTURE

(71) Applicant: NVIDIA Corporation, Santa Clara, CA (US)

(72) Inventor: Dileep Ranganathan, San Jose, CA (US)

(21) Appl. No.: 19/049,124

(22) Filed: Feb. 10, 2025

(51) Int. Cl. G06F 11/07

(52) U.S. Cl. CPC G06F 11/0793

(57) ABSTRACT

Disclosed are apparatuses, systems, and techniques that implement software-agnostic diagnostic of nodes within a deep learning environment. Monitoring agents within a node and external to a node can track metrics according to a policy provided by a controller. Upon identification of a metric violating a policy criterion, the monitoring agents can provide a policy violation notification to the controller. The controller can use the policy violation notification to determine the reliability of the node. Upon determination that the node is unreliable, the node may be prevented from receiving future task processing assignments.

### TECHNICAL FIELD

At least one embodiment pertains to processing resources and techniques that are used to improve robustness and reliability of computational applications and devices. For example, at least one embodiment pertains to hardware-based networks for managing node processing assignments based on monitoring agent and nodal communications.

### BACKGROUND

A graphics processing unit (GPU) cluster is a group of nodes (e.g., physical computers, virtual machines, containers, etc.) that provide accelerated computing power for specific computational tasks, such as image and video processing, training neural networks (e.g., deep learning neural networks) and other machine learning algorithms. GPU nodes can simultaneously process input data for task execution. During execution of a task, nodes can encounter errors that prevent one or more of these nodes from processing respective data. A failure of a single node can irreparably compromise the task execution such that the task cannot be fully executed.

### BRIEF DESCRIPTION OF DRAWINGS

FIG. 1 is a schematic block diagram of an example system architecture providing preemptive fault detection, according to at least one embodiment;

FIG. 2 is a schematic block diagram of an example node with monitoring agents for preemptive fault detection, according to at least one embodiment;

FIG. 3 illustrates an example communication flow between a controller and a monitoring agent, according to at least one embodiment.

FIG. 4 is a flow diagram of an example method facilitating software-agnostic preemptive node fault detection, according to at least one embodiment;

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 is an example data flow diagram for an advanced computing pipeline, according to at least one embodiment;

FIG. 8 is a system diagram for an example system for training, adapting, instantiating and deploying machine learning models in an advanced computing pipeline, according to at least one embodiment;

FIG. 9A is a block diagram of an example generative language model system suitable for use in implementing at least some embodiments of the present disclosure;

FIG. 9B is a block diagram of an example embodiment in which the generative LM includes a transformer encoder-decoder, according to at least one embodiment;

FIG. 9C is a block diagram of an example embodiment in which the generative LM includes a decoder-only transformer architecture, according to at least one embodiment; and

FIG. 10 is a block diagram of an example computing device suitable for use in implementing some embodiments of the present disclosure.

### DETAILED DESCRIPTION

Aspects of the present disclosure are directed to preemptive node fault detection for a deep learning infrastructure.

As discussed above, a GPU cluster is a group of nodes (e.g., physical computers, virtual machines, containers, etc.) that provide accelerated computing power for specific computational tasks, such as image and video processing, training neural networks (e.g., deep learning neural networks), running neural networks, etc. GPU nodes can simultaneously process input data for task execution. During execution of a task, nodes can encounter errors that prevent one or more of these nodes from processing respective data. A failure of a single node can irreparably compromise the task execution such that the task cannot be fully executed.

To monitor task failure caused by nodal failure, previous solutions have typically relied upon tracking node performance during execution of a task. Detection of a failure has traditionally required halting the execution, and performing diagnostics to identify the node that has caused the failure. Following identification of the failure inducing node, the task should be entirely re-executed on other nodes. Existing technologies, such as polling-based fault detection, cannot identify potentially problematic nodes within a deep learning network prior to task assignment due to timing constraints. For example, to check the health of a node, current technologies, such as polling-based fault detection, usually rely on sending a request for a health check, waiting for the node to determine health or return relevant data points, and assessing whether the node is faulty. This process typically involves sorting through data logs to identify potential problems. However, retrieving and accurately analyzing data logs may consume significant time, preventing execution of a task. Further, data logs may be missing information or may not store information for long enough for errors to be properly diagnosed.

Aspects of the present disclosure address the above and other deficiencies associated with real time fault detection for GPU nodes in neural network infrastructures by executing routine and comprehensive health checks on one or more nodes prior to a node transitioning to an in-flight, or executing, state. In some embodiments, a preemptive fault detection system is provided that can utilize one or more node and system monitoring agents to identify and interpret data to accurately and timely detect unhealthy nodes. For example, the preemptive fault detection system can be used to diagnose or predict potential problems of nodes currently in an idle state. Data can include, for example diagnostic information from Xid messages, thermal data, and power data.

In some embodiments, to detect unhealthy nodes, a controller can identify one or more policies for one or more metrics pertaining to node performance. The policies can be distributed to monitoring agents and can identify a metric, provide a policy violation criterion associated with the metric, and include instructions for providing a policy violation callback upon determination of a policy criterion violation. After identifying the policy violation callback, the controller can verify the metric as indicating node fault and can flag a respective node as unhealthy. In some embodiments, the flag can be provided to, or utilized by, a scheduler to prevent assignment of the unhealthy node to a task. For example, the controller can identify temperature as a health metric to be monitored. The controller may then identify agents within a system that can track temperature that would affect one or more nodes. A policy can be defined that identifies temperature as a metric, specifies a temperature threshold (e.g., 75° C.), and requests to generate a policy violation notification (“policy violation callback”) if it is determined that the temperature has increased above 75° C. In some embodiments, upon receiving an indication that the temperature has risen above 75° C., the controller may flag the node as an unhealthy node, such that the scheduler will not assign the node a portion of the task to execute.

In some embodiments, policies can cover more than one metric to trigger a policy violation callback to generate a more complex evaluation. For example, a policy may indicate that a first metric should meet a first criterion and a second metric should meet a second criterion in order to violate the policy and trigger a policy violation callback. Using both the first metric and the second metric, the controller can determine the health of the node. Additionally, upon receiving policy violation callbacks, a controller may complete further checks to determine if the policy violation indicates an unhealthy node. For example, if policy violation callback indicates that the policy has been violated, such that a metric has exceeded a threshold, the controller may access additional data, such as Xids, from data logs to determine if the policy violation is an indicator of a node health problem or is an isolated policy violation. Xids can be, for example, error reports that are provided from a driver that is appended to the operating system's kernel log or event log.

In some embodiments, the controller is a central controller communicatively coupled to a plurality of monitoring agents via a network. The monitoring agents can each be associated with one or more of a plurality of nodes of a network. The central controller can be used to determine a policy for a metric of a node of the plurality of nodes. The policy can, in some embodiments, comprise a metric identifier associated with the metric, a policy violation criterion associated with the metric, and/or an instruction for a policy violation notification upon identification of satisfaction of the policy violation criterion. The metric can be associated with a monitoring agent of the plurality of monitoring agents. In some embodiments, the metric can be one of Xid diagnostic data for the node or a characteristic of the node.

The central controller, in some embodiments, can be used to provide the policy to the monitoring agents and, upon the metric satisfying the policy violation criterion, obtain the policy violation notification from the monitoring agent. In some embodiments, the policy violation notification from the monitoring agent can comprise the metric identifier and metric data.

In some embodiments, the central controller can determine that the node is unreliable based on the metric data and can prevent the node from receiving a task processing assignment. Determining the node is unreliable can include obtaining the policy violation notification from the monitoring agent, and determining, based on secondary metric data from a secondary source, whether the policy violation notification indicates a node health problem or an isolated policy violation. In some embodiments, the secondary source can be a second node of the plurality of nodes.

In some embodiments, each of the plurality of nodes can be a graphical processing unit (GPU) node of a GPU cluster. In some embodiments, each of the plurality of nodes can be a physical machine, virtual machine, or a container. In some embodiments, the plurality of monitoring agents can be configured to monitor two or more nodes of the plurality of nodes. In some embodiments, the monitoring agent can reside on the node and/or on a device coupled to the network of the plurality of nodes. In some embodiments, obtaining the policy violation notification can include identifying a flag setting provided by the monitoring agent.

Accordingly, aspects of the present disclosure are able to prevent node failure during execution of a task ultimately causing an entire node processing project to be restarted. Additional advantages include real time monitoring of data that prevents a need for technician or the like from having to dig through data logs to identify what caused the failure. Real time monitoring of various data collections can locate and preemptively determine a potential issue that may arise and the node that may need to be removed from task assignment consideration.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs), small language models (SLMs), vision language models (VLMs), and multimodal language models (MMLMs) (which may process text, voice, image, and/or other data types to generate outputs in one or more formats), systems implemented at least partially using cloud computing resources, systems for performing generative AI operations, and/or other types of systems.

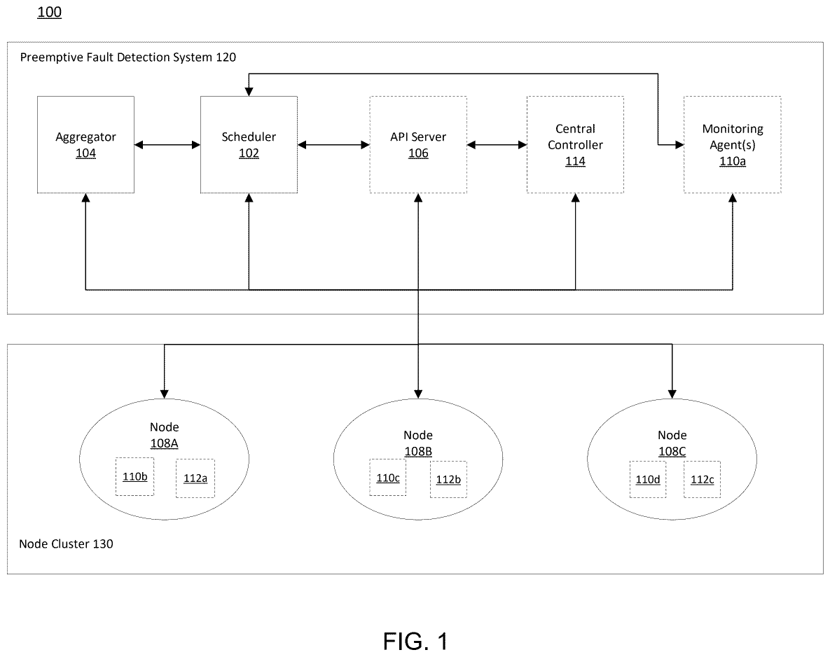

FIG. 1 is a schematic block diagram of an example system architecture 100 providing preemptive fault detection, according to at least one embodiment. The system architecture 100 can include a preemptive fault detection system 120 for enabling preemptive fault detection of nodes of node cluster 130 used for neural network infrastructures. Preemptive fault detection can be performed by executing routine and comprehensive health checks on one or more nodes prior to a node transitioning to an in-flight, or executing, state. The preemptive fault detection system 120 can be hosted by one or more computer systems including, for example, a server machine, a personal computer, a set-top box (STB), a network router, switch or bridge, or any device capable of executing a set (or multiple sets) of instructions to perform any one or more of the methods discussed herein. The preemptive fault detection system 120 can be connected to nodes of the node cluster 130 via a network such as a public network (e.g., the Internet), a private network (e.g., a local area network (LAN) or wide area network (WAN)), a wired network (e.g., Ethernet network), a wireless network (e.g., an 602.11 network or a Wi-Fi network), a cellular network (e.g., a Long Term Evolution (LTE) network), routers, hubs, switches, server computers, and/or a combination thereof. As depicted in FIG. 1, the preemptive fault detection system 120 can include an application program interface (API) server 106, an aggregator 104, and a scheduler 102. In some embodiments, the preemptive fault detection system 120 further includes a central controller 114 and/or one or more monitoring devices 110a.

The API server 106 can be, in some embodiments, a primary interface for managing the nodes 108. For example, the API server 106 can authenticate action requests, control the state of the nodes 108, track node 108 state, explore heath metrics and data logs of nodes 108, and the like. The API server 106 can keep a list of nodes, the state those nodes are in, and the availability of those nodes for task assignment. For example, the API server 106 may indicate a node 108 is in a rest state or an idle state and can accept a task and may assign a processing task to the node 108. The API server 106 may identify a potentially faulty node that cannot be allocated tasks for execution and prevent task allocation to the potentially faulty node 108. In traditional systems, the API server 106 receives and interprets logs in a manner that may not provide for preemptive fault detection, such that the API server 106 may still list the faulty node as available for task assignment even if that node may fail if assigned the task. The aggregator 104 can allow for one or more additional API servers controlling various sets of nodes 108 to be combined and controllable by a singled API server, for example API server 106. In some embodiments, the aggregator 104 can be a node health aggregator that collects health information, such as log data, for nodes 108 assigned to the various API servers and provides them to a central API server for node health checks.

The scheduler 102 can manage and optimize the execution of the tasks on the nodes 108. In some embodiments, the scheduler 102 can be responsible for resource allocation for resources such as GPU cores, memory and bandwidth. In some embodiments, the scheduler 102 can be responsible for executing task concurrently on separate nodes 108, memory management, batch execution, load balancing, synchronization, performance optimization, and the like. In some embodiments, the scheduler 102 maintains a list of available nodes 108 for task assignment. Based on an identified potential fault or previous fault, the scheduler 102 may prevent a node 108 from task assignment. In some embodiments, the scheduler 102 may receive an indication of node health from the API server 106 after the API server 106 has interpreted the data provided by the aggregator 104.

In some embodiments, monitoring agents 110 are used to monitor actions of or performance metrics associated with the nodes 108. For example, in some embodiments, a monitoring agent 110 may monitor thermal data such as the temperature of a node 108 (e.g., node 108A, node 108B, node 108C, etc.). In some embodiments, the monitoring agent 110 may monitor power data such as power consumption of a node 108. In some embodiments, the monitoring agent 110 may monitor connections between nodes 108. In some embodiments, monitoring agents 110 may collect Xid data from logs. Additional types of performance metrics can be collected by one or more monitoring agents 110. In some embodiments, each node 108A-108C may include one or more monitoring agents 110b-110d. Alternatively or in addition, one or more monitoring agents 110a can be part of the preemptive fault detection system 120 to monitor multiple nodes 108 via a network. In some embodiments, each node 108A-108C may include a node controller 112a-112c to communicate with one or more monitoring agents of the node. Alternatively or in addition, the preemptive fault detection system 120 may include a central controller 114 to communicate with node controllers 112a-112c or with the monitoring agents 110b-110d directly.

To determine a fault or potential fault, the preemptive fault detection system 120 can utilize fault detection methods, such as collection of log data and consumer feedback of a negative outcome after the fault has occurred. Further, the preemptive fault detection system 120 can preemptively identify unhealthy nodes using one or more monitoring agents 110 and one or more of a central controller or node controllers 112a-112c cooperating with monitoring agents 110 for nodes 108. For example, a monitoring agent 110a can track metrics for a group of nodes 108A-108C and provide these metrics to the central controller 114 which can detect issues such as interconnectivity and/or communication lags or issues between the nodes 108A-108C. The central controller 114 can then identify a potential node fault from the metrics and provide an identification of affected nodes 108A-108C to the scheduler 102. Upon receiving the notification of the nodes 108 that may be affected by the communication issues, the scheduler 102 may refrain from scheduling tasks on the affected nodes 108. In some embodiments, the API server 106 may also receive an indication of potentially faulty nodes 108 based on the collected metrics at the monitoring agent 110a from the monitoring agent 110a and/or the central controller 114 to maintain a list of healthy nodes and/or identify to an external source of a need for repair of the nodes 108. For example, the API server 106 may identify one or more communication links between the affected nodes 108 and can provide the links to a user to replace the communication links, such as antennas, wires, or wireless connection devices.

In some embodiments, the central controller 114 may provide policies for the node 108A-108C to the monitoring agents 110b-110d that can be verified according to the metrics collected at the monitoring agents. The policy may include a threshold for meeting the policy and/or instructions on providing policy violation notifications to the central controller or corresponding node controller 112 in the event of a policy violation detected at the monitoring agent 110. For example, for a monitoring agent 110 tracking thermal data for a node 108, the policy may require the monitoring agent 110 notify the central controller 114 on the condition that the temperature of the node 108 has risen too high. To determine when to notify the central controller 114, the monitoring agent 110 can use the threshold, for example a temperature of 75° C. Once the monitoring agent 110 determines the temperature is above 75° C., the monitor agent 110 can notify the central controller 114 of the policy violation.

In some embodiments, a policy violation notification can be a message provided to the central controller 114 or node controller 112 from the monitoring agent 110 upon detection of the policy violation. In some embodiments, the policy violation notification can be a flag at the monitoring agent 110 that the monitoring agent 110 raises upon identification of the policy violation. In some embodiments, the central controller 114 or node controller 112 can identify the raised flag and can lower the flag after identifying the violation. In some embodiments, the central controller 114 or node controller 112 can direct the monitoring agent 110 to lower the flag once the central controller 114 or node controller 112 has identified the flag and the metric indicated by the violation.

In some embodiments, the monitoring agents 110b-110d can provide the data associated with the policy violation along with the policy violation notification. The data can be utilized by the central controller 114 or node controller 112 and/or can be provided to the scheduler 102 and/or the API server 106 for additional interpretation. For example, if a monitoring agent 110b has been provided a policy for tracking a power consumption that exceeds threshold at 250 W, the monitoring agent 110b may monitor power consumption of the node 108a to determine if the policy is violated. Upon determining the power consumption reached 251 W, the monitoring agent 110b can relay a policy violation notification to the node controller 112a. Upon obtaining the policy violation notification, the node controller 112a can receive and/or request the accompanying data, for example the violating power consumption of 251 W.

In some embodiments, the node controller 112a can utilize the data to determine whether a node is unhealthy and should be prevented from being assigned a task. For example, responsive to a power consumption increase of 1 W over the threshold of 250 W the node controller 112a may determine the power increase is within a margin of error and ignore the policy violation. In some embodiments, the node controller 112a may use the data in combination with previous data from the same or different sources. For example, the node controller 112a may identify the power consumption of 1 W over the threshold and may check previous power consumption policy violations for the node 108a. Upon determining the policy violation is a pattern that indicates an unhealthy node or worsening violations, the node 108a may be removed from task execution consideration. For example, if two previous threshold violations show the power consumption violation increasing from 0.4 W over the threshold to 0.7 W over the threshold, resulting in the current 1 W threshold violation, the node controller 112a may identify the node 108a as trending towards more severe policy violations. In some embodiments, the node controller 112a can communicate the data to the node controller 114 which may compare the data to log data retrieved from one or more other nodes 108 of the node cluster 130.

In some embodiments, the node cluster 130 may be part of a graphical processing unit (GPU) neural network infrastructure. Within a GPU neural network infrastructure, the nodes 108 can be nodes executed in parallel by the GPU cores, hardware nodes, and the like, and monitoring agents 110 can monitor the nodes. In some embodiments, each node 108 of the node cluster 130 is one of a physical machine, virtual machine, and/or a container.

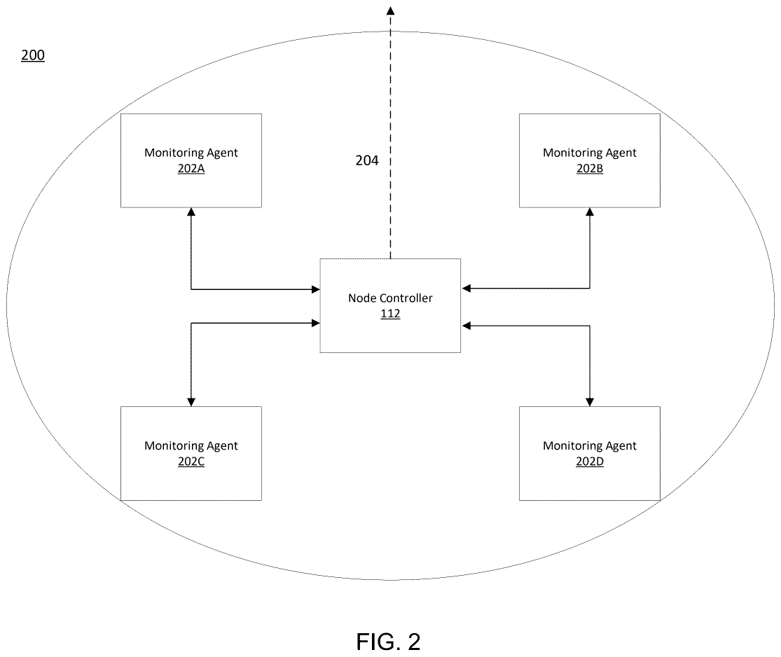

FIG. 2 is a schematic block diagram of an example node 200 with monitoring agents 202 for preemptive fault detection, according to at least one embodiment. As shown in FIG. 1, the system architecture 100 may include one or more nodes 108 that can be assigned processing tasks. FIG. 2 shows a node 200 with a node controller 112 in data communication with monitoring agents 202. The monitoring agents 202 can be constantly monitoring metrics within the node 200, or can be configured to do periodic checks on metrics within the node 200. In some embodiments, the node 200 can be a GPU node within a GPU neural network. In some embodiments, the GPU node can combine CPU resources with one or more GPUs to accelerate computation and task processing. The node 200 can be part of a GPU cluster, or a distributed system, which can be used for parallel processing of tasks. For example, the node 200 can process a first portion of the first task while a second node processes a second portion of the first task. The node 200 can utilize a CPU and can reside on a GPU core to perform the computations for processing the tasks.

In some embodiments, monitoring agents 202 can monitor one or more of CPU metrics, GPU metrics, memory metrics, storage metrics, network metrics, power supply metrics, temperature metrics, fan and cooling metrics, hardware health metrics, task specific metrics, and system health and error logs. CPU metrics can include, for example, utilization, load average, temperature, frequency, and core usage. GPU metrics can include, for example utilization, memory usage, temperature, fan speed, power consumption, clock speed, memory clock, and error counts. Memory metrics can include, for example, utilization, usage by process, and swap usage. Storage metrics can include, for example, disk I/O, I space usage, latency, and health. Network metrics can include, for example, throughput, latency, packet loss, and errors. Power supply metrics can include, for example, consumption, supply voltage, and UPS status. Temperature metrics can include, for example, note temperature and ambient temperature. Fan and cooling metrics can include, for example, fan speed and cooling system performance. Hardware health metrics can include, for example, hardware errors, temperature sensors, and system logs. Task specific metrics can include, for example, tensor operations, CUDA core utilization, and kernel launches. System health and error logs can include, for example, system event logs and hardware failures. Additional metrics within the groups above and metrics associated monitoring the health of nodes can be monitored by monitoring agents such as Xid, ECC, NVLink, PCie, etc.

In some embodiments, a monitoring agent 202 can be configured to monitor one or more metric. For example, monitoring agent 202A can be configured to monitor GPU metrics such as clock speed and memory clock. Monitoring agent 202B can be configured to monitor one or more metrics such as power consumption, supply voltage, and UPS status. Monitoring agent 202C can be configured to monitor node temperature. Monitoring agent 202D can be configured to monitor ambient temperature. Some metrics being monitored by monitoring agents 202 may require constant monitoring. For example, spikes in power consumption monitored by monitoring agent 202B could indicate an unreliable node, whereas ambient temperature monitored by monitoring agent 202D, may change infrequently such that the ambient temperature need only be collected at regular intervals. In some embodiments, the monitoring agent 202 can be a tool such as a Node Problem Detector, dcgm-health, node-aggregator, etc.

The interval at which the metric is monitored, may be provided by the node controller 112 of the node 200. For example, when a policy for monitoring a specific metric is defined, the policy may include a threshold (e.g., a criterion) at which a node may be considered unhealthy and/or unreliable. The policy may further contain a policy violation notification which defines an action to be taken by a monitoring agent upon the detection of a metric satisfying the policy violation criterion (e.g., exceeding the threshold). The policy may include directions for the monitoring agent 202 to identify the metric at an interval. Using the examples above, the node controller 112 may use the policy to direct monitoring agent 202A to continuously monitor clock speed and monitoring agent 202B to continuously monitor one or more of the power metrics. The node controller 112 may also provide a policy for monitoring agent 202D for the ambient temperature metric, that directs the monitoring agent 202D to collect ambient temperature data every five milliseconds.

Depending on the policy violation notification, the node controller 112 can receive and/or retrieve data or indication of the policy violation from the monitoring agents 202. Node controller 112 can determine the health of the node 200 based on the obtained policy violation notifications and data and may provide a notification via a data communication method 204 to the scheduler 102 and/or the API server 106 of the preemptive fault detection system 120 of the unreliability of the node, causing the node to be prevented from receiving future task assignments. In some embodiments, the node controller 112 may make a node reliability determination and/or may provide the policy violation notification and data to the scheduler 102 and/or the API server 106 for node reliability determinations. In some embodiments, the scheduler 102 and/or the API server 106 may act as a central controller by interpreting policy violations and/or metrics provided from node controllers of the node 200. In some embodiments, the scheduler 102 and/or the API server may act as a supplemental central controller, receiving unreliability determinations from the node controller 112 for the node 200 or a central controller 114, and interpreting metrics external to the node 200 from monitoring agents 110 monitoring other nodes.

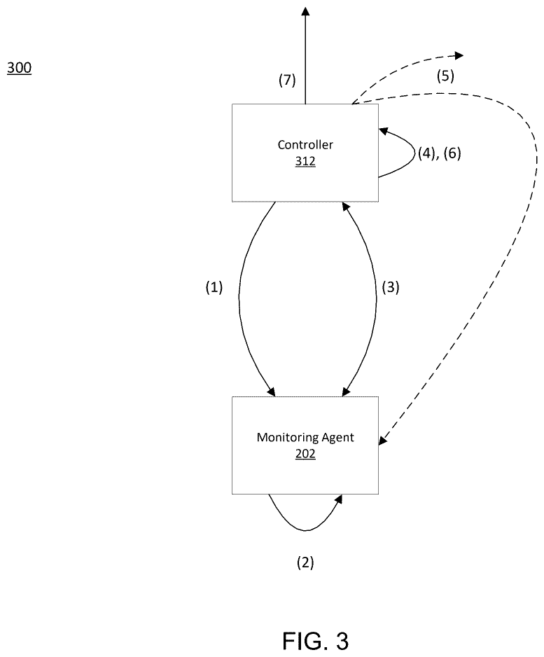

FIG. 3 illustrates an example communication flow 300 between a controller 312 and a monitoring agent 202, according to at least one embodiment. In some embodiments, the controller 312 is the central controller 114 of the preemptive fault detection system 120. Alternatively, the controller 312 is the node controller 112 of the node 108. The controller 312 can provide a policy (1), as described above, to the monitoring agent 202 to direct the monitoring agent 202 to monitor a metric. In some embodiments, the policy can include one or more metrics, thresholds, policy violation criterion, and policy violation notifications for the monitoring agent 202 to direct the monitoring agent 202 to monitor one or more metrics. In some embodiments, the controller 312 can provide multiple policies separately to the monitoring agent 202 to direct the monitoring agent 202 to monitor one or more metrics.

The monitoring agent 202 may utilize the policy to change settings (2) for the monitoring agent 202. A setting for the monitoring agent 202 may include, in some embodiments, communication methods with the controller 312, intervals at which metrics are monitored, thresholds and policy violation criterions for metrics, and the like. For example, a monitoring agent 202 may have a preset setting for communications with the controller 312.

Upon receiving a policy that indicates a policy violation notification, the monitoring agent 202 may be required to adjust the setting for communications with the controller 312 to provide policy violation notifications as directed by the policy. For example, the monitoring agent 202 may be initialized to raise a flag upon identification of a metric satisfying the policy violation criterion, whereas the policy may direct the monitoring agent 202 to provide the data and the metric to the controller 312 through a push notification upon detection of a metric satisfying a policy violation criterion. In some embodiments, monitoring agents 202 may monitor one or more metrics associated with policies from the controller 312. In such embodiments, the monitoring agent 202 may have one or more methods of communication with the controller 312 based on the policies. The monitoring agent 202 may be configured to enable the controller 312 to obtain the policy violation notification based on the policy for each individual metric.

Upon detection of a metric satisfying a policy violation criterion (e.g., exceeding a threshold), the monitoring agent 202 may allow the controller 312 to obtain (3) the policy violation notification, metric, and/or metric data according to the policy. In some embodiments, obtaining the policy violation notification can include the monitoring agent 202 raising a flag, pushing the requested data to the controller 312, and the like. In some embodiments, the controller 312 may periodically prompt the monitoring agent 202 to provide status updates for all metrics being monitored by the monitoring agent 202.

The controller 312 may use the obtained policy violation notification to determine the reliability of the node (4). In some embodiments, the reliability of the node can be assessed based on the node being healthy or unhealthy. In some embodiments, the obtained policy violation notification can be accompanied by metric data that can be used to determine whether the node is unreliable. For example, metric data that indicates a large deviation of the metric data from the policy violation criterion may be more likely to be interpreted by the controller 312 as indication of an unreliable node over a small deviation of the metric data from the policy violation criterion. For example, determining that a node 200 is unreliable based on temperature data provided by the monitoring agent 202, the controller 312 may request ambient temperature from a monitoring agent that reside external to the node 200 or on a monitoring agent 202 within the node, that is not the notifying monitoring agent 202. The controller 312 may further require temperature data from the monitoring agent 202 to determine the reliability of the node. For example, upon notification that the temperature data indicates that the temperature exceeds the threshold, the controller 312 may prompt the monitoring agent 202 to supply additional temperature data taken subsequent to the first provided temperature data.

Using both instances of temperature data, the controller 312 may make an additional attempt (6) to determine if the node is unreliable based on the additional gathered data and the initial data provided. For example, increased ambient temperature may indicate to the controller 312 that the node 200 is merely increasing in temperature because of an ambient air issue, and not because the node 200 is unreliable. Additionally, if subsequently collected temperatures of the node 200 are provided by the monitoring agent 202 indicate temperature is rising, the temperature data may indicate the unreliability of the node 200. It should be appreciated that collection of additional data and subsequent determinations on node reliability can be performed iteratively, such that the process is repeated one or more times until a determination can be made based on the policy violation notification originally received. In some embodiments, upon determining the node is not unreliable, the controller 312 may direct the monitoring agent 202 to lower the flag or otherwise reset monitoring the metric.

In some embodiments, after determining that the node 200 is unreliable, the controller 312 may provide a notification (7) external to the node 200. In some embodiments, the notification may be provided to a scheduler 102 or an API server 106. The scheduler 102 or the API server 106 can cause the node 200 to be avoided when assigning processing tasks in the future.

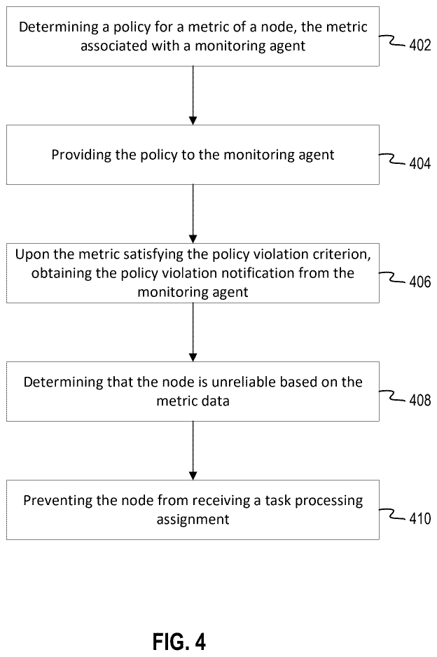

FIG. 4 is a flow diagram of an example method 400 facilitating software-agnostic preemptive node fault detection, according to some embodiments of the present disclosure. Method 400 may be performed in the context of cloud-based programming, computational simulations, autonomous driving applications, industrial control applications, provisioning of streaming services, video monitoring services, computer-vision based services, artificial intelligence and machine learning services, mapping services, gaming services, virtual reality or augmented reality services, and many other contexts, and/or in systems and applications for providing one or more of the aforementioned services. Method 400 may be performed using one or more processing computing devices (e.g., CPUs, GPUs, accelerators, PPUs, DPUs, etc.), which may include (or communicate with) one or more memory devices. In at least one embodiment, method 400 may be performed using preemptive fault detection system 120, one or more monitoring agents 110, one or more node controllers 112, one or more central controllers 114, and one or more nodes 108. In at least one embodiment, some of the processing units performing any operations of method 400 may be executing instructions (e.g., firmware or software) stored on non-transient computer-readable storage media. In some embodiments, some of the processing computing devices performing any of the operations of method 400 may be hardware circuits that operate without software involvement. In at least one embodiment, any of method 400 may be performed using multiple processing threads, individual threads executing one or more individual functions, routines, subroutines, or operations of the method. In at least one embodiment, processing threads implementing any of method 400 may be synchronized (e.g., using semaphores, critical sections, and/or other thread synchronization mechanisms). Alternatively, processing threads implementing any of method 400 may be executed asynchronously with respect to each other. Various operations of any of method 400 may be performed in a different order compared with the order shown in FIG. 4. Some operations of any of method 400 may be performed concurrently with other operations. In at least one embodiment, one or more operations shown in FIG. 4 may not always be performed.

FIG. 4 is a flow diagram of an example method 400 facilitating software-agnostic preemptive node fault detection, according to some embodiments of the present disclosure. The method 400 is executed using one or more computing devices which may include be at least one computing component device, e.g., a processing device (GPU, CPU, PPU, DPU, ASIC, MPGA, and/or the like), a network controller device, and/or some other component device. In one example embodiment, the plurality of computing devices may include one or more of a power management computing device, a temperature control computing device, a GPU system processor, a foundation security processor, and/or the like. In some embodiments, each computing device of the plurality of computing devices may include (or be communicatively coupled or otherwise associated with) a respective computing device controller of a plurality of computing device controllers. In some embodiments, a single computing device controller may serve multiple computing devices.

At block 402, method 400 may begin by determining a policy for a metric of a node of the plurality of nodes. The policy can comprise a metric identifier associated with the metric, a policy violation criterion associated with the metric, and an instruction for a policy violation notification upon identification of satisfaction of the policy violation criterion. In some embodiments, the metric is associated with a monitoring agent of the plurality of monitoring agents. In some embodiments the metric can include metrics related to an individual core processing tasks such as load and/or utilization, temperature, and clock frequency. In some embodiments, metrics can identify memory usage such as percentage of memory used, node swapping usage, and/or memory failures. In some embodiments, core features can be monitored and data associated with the core feature can be collected as a metric such as fan speed. In some embodiments, the computing system 100 can be a GPU system, wherein metrics can be GPU specific metrics that track a driver or hardware functionality. In some embodiments, the metric can be Xid or other diagnostic data types.

In some embodiments, the monitoring agent can be on a device external to one or more nodes of the computing system 100. The monitoring agent can then be configured to monitor one or more nodes to determine metrics associated with network connection, latency, packet loss, and the like. In some embodiments, the monitoring agents can be within the node of the computing system 100 and can be configured to monitor one or more metrics for the node.

In some embodiments, when creating the policy, the computing system 100, for example, at the scheduler and/or the API server can determine an acceptable value for the metric within the policy. In some embodiments the acceptable value can be a range of values in which deviation below the range and above the range can indicate an issue with the node according to that metric. For example, a policy directed to the temperature of a single node, may identify and acceptable upper limit of temperature to be 75° C. Any deviation above 75° C. would exceed the criterion. In some embodiments, the value of the criterion can be provided with the policy to the controllers as a threshold to direct monitoring devices to identify the metric exceeding the threshold.

In some embodiments, a policy can include one or more metrics, criterion, and thresholds to a single monitoring agent or one or more monitoring agents configured to monitor the one or more metrics. For example, a monitoring agent may be configured to monitor network connections between nodes. The policy could include a first metric of latency and a second metric of packet loss. Each metric could be provided with a criterion and a threshold such that the monitoring agent can monitor each metric for policy violations. In some embodiments the policy may require a violation of the first metric and the second metric to constitute a policy violation and trigger a policy violation notification.

In some embodiments, the policy can include a policy violation notification. The policy violation notification can indicate a process and/or a method for the monitoring agents to execute upon detection of a metric exceeding the threshold. In some embodiments, a policy violation notification may include directions to set a flag recognizable by the one or more controllers, providing a notification message to the controllers, providing the data indicating the threshold violation to the controllers, and the like. In some embodiments, the controllers may be configured to monitor the monitoring agents to identify a change in flag status. For example, a policy violation notification may cause the monitoring agent to raise a flag upon detection of the temperature of a node exceeding the threshold of 75° C. The controller may then identify the raised flag and may then act according to preset or learned procedures to identify the node as heathy or unhealthy.

After creating the policy for the metric of the node, the method 400 continues at block 404 by providing the policy to the monitoring agent. In some embodiments, one or more nodes with similar configurations may include within the node monitoring agents for each individual node. For example, nodes 108A-108C may all be GPU nodes as part of a GPU cluster, each GPU node housed on a GPU core. A policy for temperature monitoring, may be required for each GPU core. As such, the monitoring agents 110b-110d may be provided the same policy simultaneously from the scheduler and/or the API server. In some embodiments, the server and or the scheduler may provide instructions to the node controllers 112 within the nodes to monitor the health of the individual node. Using learned metrics and/or previously established metrics of a healthy node, the node controllers may create the policy and provide it to the monitoring agent of each node respectively. In some embodiments, the policy may be provided using a wireless connection, a wired connection, or the like. In some embodiments, a user may utilize the API server to set the policies and/or violation metrics.

Upon the metric satisfying the policy violation criterion, the method may continue at block 406 with obtaining the policy violation notification from the monitoring agent. As described above, the policy violation notification can be provided in a variety of ways. The controller, scheduler and/or the API server may retrieve the policy violation notification from the monitoring agent or may receive the policy violation notification from the monitoring agent. For example, each monitoring agent may have a single flag and may monitor multiple metrics. Upon identifying a raised flag at the monitoring agent, the controller, scheduler, and/or the API server may send a message to the monitoring agent requesting additional data to determine which metric policy has been violated. In some embodiments, upon determining the metric satisfies the policy violation criterion, the monitoring agent may provide a message and or other type of communication to the controller, scheduler, and/or the API server to notify of the violation. In some embodiments, monitoring agents may reside within a node and external to a node, for example on a device in data communication with the computing system 100. Each monitoring agent may provide data to, or may have data retrieved by, one or more of the node and central controllers, scheduler, and/or API server. For example, within a node, monitoring agents may only be in direct communication with the node controller, or may provide one or more policy violation notifications to the central controller, the scheduler and/or the API server. The monitoring agent on a device external to the system architecture 100, or external to the nodes, may not be in communication with the controllers of the nodes, and may instead provide data to, or have data retrieved by, the scheduler and/or the API server.

At block 408, method 400 may cause the computing system 100 to determine that the node is unreliable based on the metric data. In some embodiments, the policy violation notification may be provided to the controller from the monitoring agent with data associated with the policy violation criterion. For example, a policy violation notification indicating the temperature has exceeded the threshold of 75° C., such that the policy violation criterion is satisfied, the monitoring agent may provide the controllers with the data indicating the temperature at the time the policy violation criterion is satisfied. In some embodiments, an isolated incident of a metric satisfying the policy violation criterion, may not be indicative of a node's reliability. For example, metric data indicating a temperature of 75.1° C. may not be a large enough deviation from the policy violation criterion (e.g., does not exceed the threshold by a large enough margin). The controller may then determine that the node is not unreliable.

In some embodiments, repeated temperature increases happening over multiple policy violation notifications, policy violation notifications related to sensitive metrics, and/or large deviations in the metric data from the policy violation criteria may indicate an unreliable node. For example, obtaining repeated policy violation notifications from the monitoring agent regarding the temperature metric, wherein each subsequent temperature data indicates the temperature is rising, may cause the controller to determine that the node is unreliable. For example, a policy violation notification related to network communications between nodes indicating connection is not sufficient may cause the controller to determine the node is unreliable without requiring the network communication data to determine the deviation from the policy violation criterion. In some embodiments, metric data may indicate a large deviation from the policy violation criterion, such as a spike in temperature or power consumption. As such, the controller may identify a large deviation as an indication that the node is unreliable.

In some embodiments, determining that the node is unreliable utilizes secondary metric data from a secondary source, to determine whether the policy violation notification indicates a node health problem or an isolated policy violation. For example, in some embodiments, nodes may utilize GPU cores, such that a first node is on a first GPU core located physically proximally to a second node that is on a second GPU core. A policy violation notification at the first node May indicate a temperature of the first GPU core exceeding the metric threshold (e.g., satisfying the policy violation criterion). The metric data for the first node may be combined with metric data associated with the temperature at the second node. For example, if the temperature of the first node is 75.1°, and the temperature of the second node is 87°, the controller, scheduler, and/or API server may determine that the temperature increase of the first node is due to the excessive heat at the second node and may determine that the first node is not unreliable.

In some embodiments, reliability determinations can happen within the controller, the API server, and/or the scheduler. For example, a reliability determination for a metric associated with a single node may be made by a controller within the node, whereas a reliability determination for network connection monitored by a monitoring agent external to the nodes, may be made by a central controller external to a node, the scheduler, or the API server.

The method 400 ends at block 410, wherein the controller prevents the node from receiving a task processing assignment. An unreliable note, while having yet to fail, may be removed from a list of nodes available for task processing assignment, preventing future failure based on the determination of unreliability based on the metrics. In some embodiments, the determination is provided to the scheduler from the controller and/or the API server, wherein the scheduler will remove the node from receiving task processing assignments.

### Inference and Training Logic

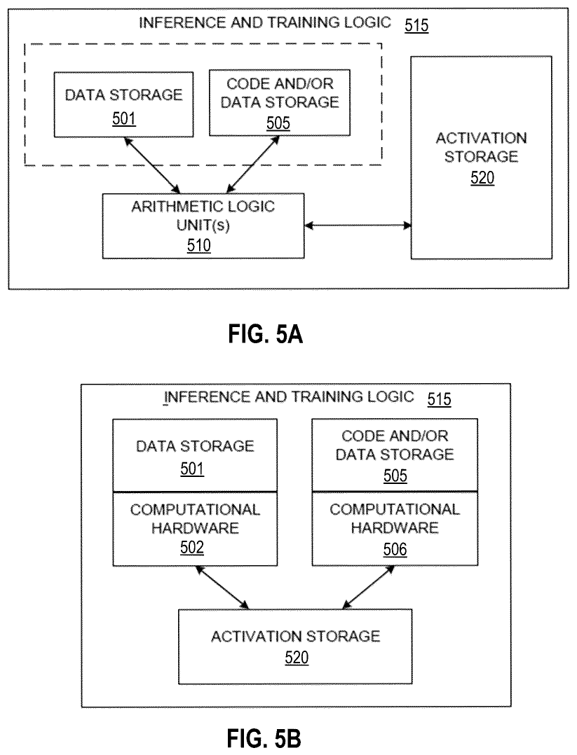

FIG. 5A illustrates inference and/or training logic 515 used to perform inferencing and/or training operations associated with one or more embodiments.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or data storage 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

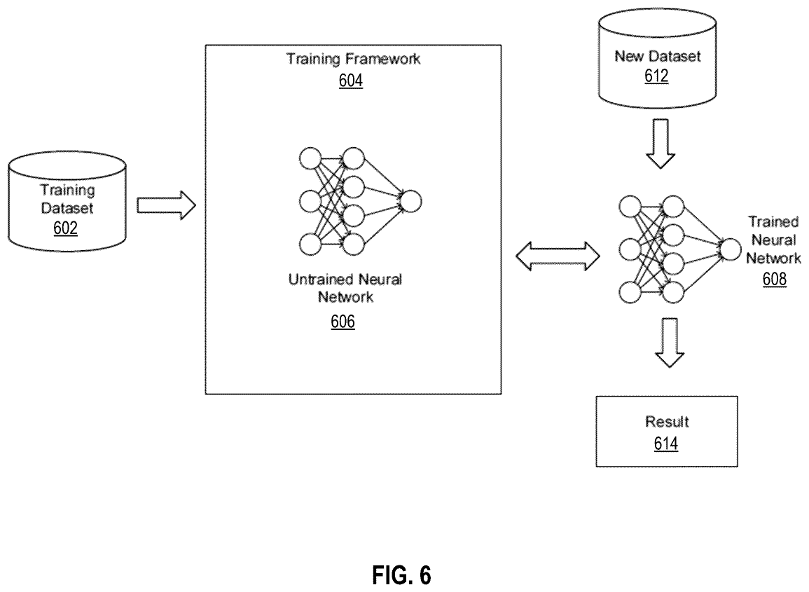

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, whereas untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

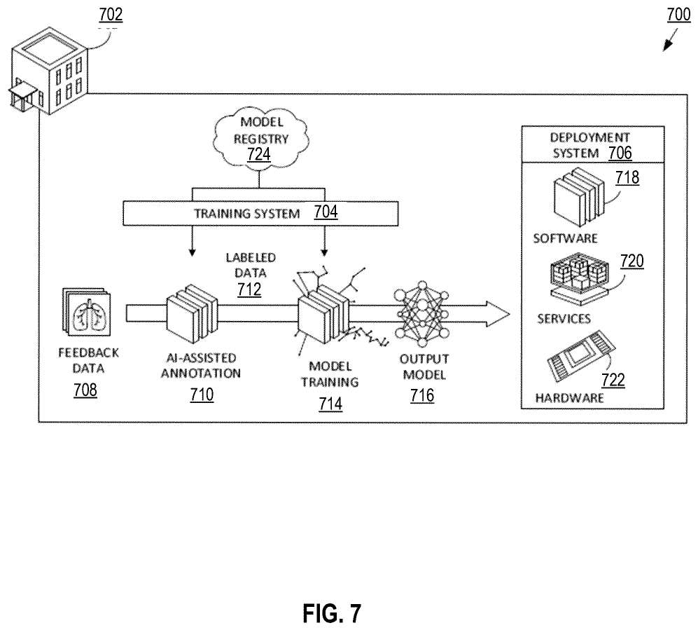

With reference to FIG. 7, FIG. 7 is an example data flow diagram for a process 700 of generating and deploying a processing and inferencing pipeline, according to at least one embodiment.. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

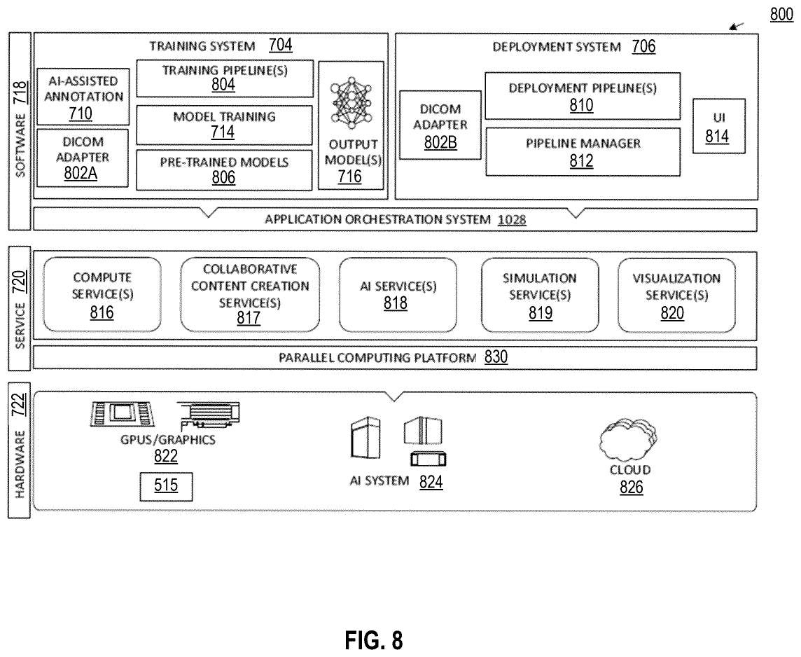

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

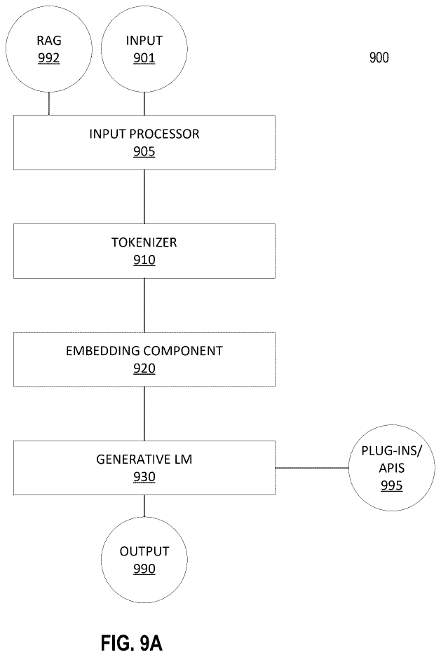

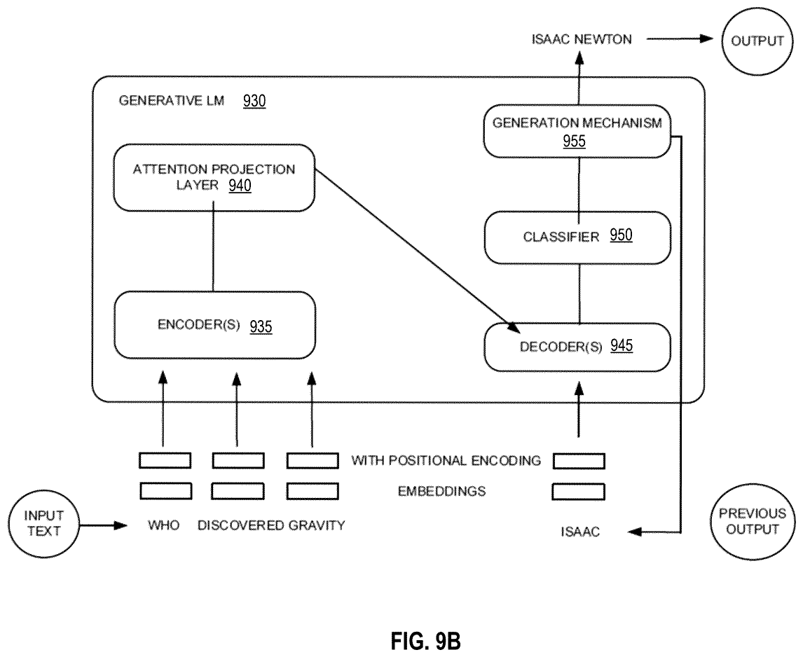

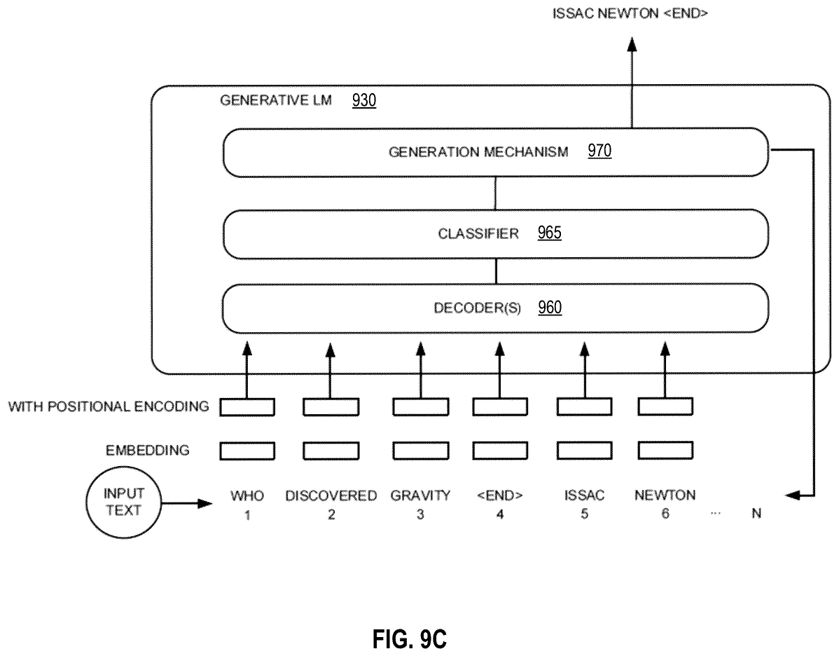

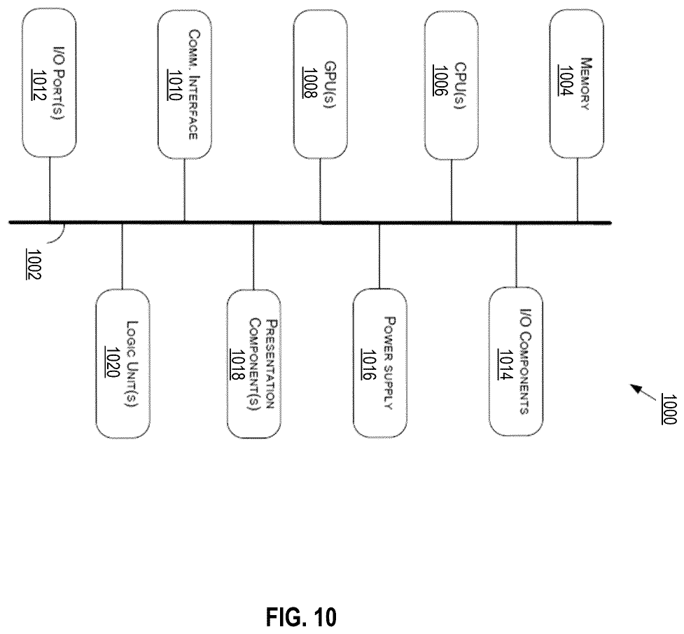

In at least one embodiment, a training pipeline 1004 (FIG. 8) may include a scenario where facility 702 is training their own machine learning model, or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIGS. 9-10. In at least one embodiment, a trained machine learning model may be referred to as an output model 716, and may be used by deployment system 706, as described herein.

In at least one embodiment, training pipeline 1004 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained —or partially trained—at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model 716—and may be used in deployment system 706 to perform one or more processing tasks for one or more applications of a deployment system.

In at least one embodiment, training pipeline 1004 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714—e.g., AI-assisted annotations 710, labeled data 712, or a combination thereof-may be used as ground truth data for retraining or updating a machine learning model.

In at least one embodiment, deployment system 706 may include software 718, services 720, hardware 722, and/or other components, features, and functionality. In at least one embodiment, deployment system 706 may include a software “stack,” such that software 718 may be built on top of services 720 and may use services 720 to perform some or all of processing tasks, and services 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage services 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 720 may be leveraged. In at least one embodiment, services 720 may include compute services, collaborative content creation services, simulation services, artificial intelligence (AI) services, visualization services, and/or other service types. In at least one embodiment, services 720 may provide functionality that is common to one or more applications in software 718, so functionality may be abstracted to a service that may be called upon or leveraged by applications. In at least one embodiment, functionality provided by services 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and services 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or services 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 9 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources.. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 704 may execute training pipelines 1004, similar to those described herein with respect to FIG. 9. In at least one embodiment, where one or more machine learning models are to be used in deployment pipelines 810 by deployment system 706, training pipelines 1004 may be used to train or retrain one or more (e.g., pre-trained) models, and/or implement one or more of pre-trained models 806 (e.g., without a need for retraining or updating). In at least one embodiment, as a result of training pipelines 1004, output model(s) 716 may be generated. In at least one embodiment, training pipelines 1004 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, for different machine learning models used by deployment system 706, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704, and may be implemented by deployment system 706.

In at least one embodiment, output model(s) 716 and/or pre-trained model(s) 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipelines 810; either in addition to, or in lieu of, AI-assisted annotation included in training pipelines 1004. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipelines 810 may include any number of applications that may be sequentially, non-sequentially, or otherwise applied to feedback data (and/or other data types), including AI-assisted annotation, as described above. In at least one embodiment, as described herein, a deployment pipeline 810 for an individual device may be referred to as a virtual instrument for a device. In at least one embodiment, for a single device, there may be more than one deployment pipeline 810 depending on information desired from data generated by a device.

In at least one embodiment, applications available for deployment pipelines 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704. In at least one embodiment, training system 704 and deployment system 706 may include DICOM adapters 802A and 802B.

In at least one embodiment, pipeline manager 812 may be used, in addition to an application orchestration system 1028, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 1028. In at least one embodiment, so long as an expected input and/or output of each container or application is known by a system (e.g., based on constructs of applications or containers), application orchestration system 1028 and/or pipeline manager 812 may facilitate communication among and between, and sharing of resources among and between, each of applications or containers. In at least one embodiment, because one or more of applications or containers in deployment pipeline(s) 810 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute services 816, collaborative content creation services 817, AI services 818, simulation services 819, visualization services 820, and/or other service types. In at least one embodiment, applications may call (e.g., execute) one or more of services 720 to perform processing operations for an application. In at least one embodiment, compute services 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA®) may enable general purpose computing on GPUs (GPGPU) (e.g., GPUs 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 818 may be leveraged to perform inferencing services for executing machine learning model(s) associated with applications (e.g., tasked with performing one or more processing tasks of an application). In at least one embodiment, AI services 818 may leverage AI system 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output models 716 from training system 704 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 720 and/or hardware 722) based on priority paths for different inferencing tasks of AI services 818.

In at least one embodiment, shared storage may be mounted to AI services 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization services 820 may be leveraged to generate visualizations for viewing outputs of applications and/or deployment pipeline(s) 810. In at least one embodiment, GPUs 822 may be leveraged by visualization services 820 to generate visualizations. In at least one embodiment, rendering effects, such as ray-tracing or other light transport simulation techniques, may be implemented by visualization services 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 820 may include an internal visualizer, cinematics, and/or other rendering or image processing capabilities or functionality (e.g., ray tracing, rasterization, internal optics, etc.).

In at least one embodiment, hardware 722 may include GPUs 822, AI system 824, cloud 826, and/or any other hardware used for executing training system 704 and/or deployment system 706. In at least one embodiment, GPUs 822 (e.g., NVIDIA's TESLA® and/or QUADRO® GPUs) may include any number of GPUs that may be used for executing processing tasks of compute services 816, collaborative content creation services 817, AI services 818, simulation services 819, visualization services 820, other services, and/or any of features or functionality of software 718. For example, with respect to AI services 818, GPUs 822 may be used to perform pre-processing on imaging data (or other data types used by machine learning models), post-processing on outputs of machine learning models, and/or to perform inferencing (e.g., to execute machine learning models). In at least one embodiment, cloud 826, AI system 824, and/or other components of system 800 may use GPUs 822. In at least one embodiment, cloud 826 may include a GPU-optimized platform for deep learning tasks. In at least one embodiment, AI system 824 may use GPUs, and cloud 826—or at least a portion tasked with deep learning or inferencing—may be executed using one or more AI systems 824. As such, although hardware 722 is illustrated as discrete components, this is not intended to be limiting, and any components of hardware 722 may be combined with, or leveraged by, any other components of hardware 722.

In at least one embodiment, AI system 824 may include a purpose-built computing system (e.g., a super-computer or an HPC) configured for inferencing, deep learning, machine learning, and/or other artificial intelligence tasks. In at least one embodiment, AI system 824 (e.g., NVIDIA's DGX™) may include GPU-optimized software (e.g., a software stack) that may be executed using a plurality of GPUs 822, in addition to CPUs, RAM, storage, and/or other components, features, or functionality. In at least one embodiment, one or more AI systems 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 1028 leveraging multiple GPUs to enable seamless scaling and load balancing between and among applications and services 720. In at least one embodiment, cloud 826 may be tasked with executing at least some of services 720 of system 800, including compute services 816, AI services 818, and/or visualization services 820, as described herein. In at least one embodiment, cloud 826 may perform small and large batch inference (e.g., executing NVIDIA's TensorRT™), provide an accelerated parallel computing API and platform 830 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a SLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 930 (e.g., LLM/SLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/SLM/VLM/MMLM/etc. with external knowledge, so that answers to specific questions or queries or requests are more relevant-such as in a case where specific knowledge is required. The RAG component 992 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 1190, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 1190, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 1190. This process may be repeated—e.g., recursively—for any number of iterations and using any number of plug-ins/APIs 995 until an output 1190 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computing system comprising:
a controller communicatively coupled to a plurality of monitoring agents associated with a plurality of nodes of a network, wherein the controller is configured to:
determine a policy for a metric of a node of the plurality of nodes, the policy comprising a metric identifier associated with the metric, a policy violation criterion associated with the metric, and an instruction for a policy violation notification upon identification of satisfaction of the policy violation criterion, wherein the metric is associated with a monitoring agent of the plurality of monitoring agents;
provide the policy violation criterion to the monitoring agent;
upon the metric satisfying the policy violation criterion, obtain the policy violation notification from the monitoring agent, the policy violation notification from the monitoring agent comprising the metric identifier and metric data;
determine that the node is unreliable based on the metric data; and
in response to determining that the node is unreliable, prevent the node from receiving a task processing assignment.

2. The computing system of claim 1, wherein the plurality of nodes comprises at least a graphical processing unit (GPU) node of a GPU cluster.

3. The computing system of claim 1, wherein the plurality of monitoring agents is configured to monitor two or more nodes of the plurality of nodes.

4. The computing system of claim 1, wherein determining that the node is unreliable comprises:
upon obtaining the policy violation notification from the monitoring agent, determining, based on secondary metric data from a secondary source, whether the policy violation notification indicates a node health problem or an isolated policy violation.

5. The computing system of claim 4, wherein the secondary source is a second node of the plurality of nodes.

6. The computing system of claim 1, wherein obtaining the policy violation notification comprises identifying a flag setting provided by the monitoring agent.

7. The computing system of claim 1, wherein the metric is one of Xid diagnostic data for the node or a characteristic of the node.

8. The computing system of claim 1, wherein the monitoring agent resides on the node.

9. The computing system of claim 1, wherein the monitoring agent resides on a device coupled to the network of the plurality of nodes.

10. The computing system of claim 1, wherein each of the plurality of nodes is one of a physical machine, virtual machine, or a container.

11. A method for preemptive node fault detection, the method comprising:
determining a policy for a metric of a node of a plurality of nodes, the policy comprising a metric identifier associated with the metric and a policy violation criterion associated with the metric, wherein the metric is associated with a monitoring agent of a plurality of monitoring agents each associated with one or more of the plurality of nodes;
providing the policy violation criterion to the monitoring agent;
upon the metric satisfying the policy violation criterion, obtaining a policy violation notification from the monitoring agent, the policy violation notification from the monitoring agent comprising the metric identifier and metric data;
determining that the node is unreliable based on the metric data; and
in response to determining that the node is unreliable, preventing the node from receiving a task processing assignment.

12. The method of claim 11, wherein the plurality of nodes comprises at least a graphical processing unit (GPU) node of a GPU cluster.

13. The method of claim 11, wherein the plurality of monitoring agents is configured to monitor two or more nodes of the plurality of nodes.

14. The method of claim 11, wherein determining that the node is unreliable comprises:
upon obtaining the policy violation notification from the monitoring agent, determining, based on secondary metric data from a secondary source, whether the policy violation notification indicates a node health problem or an isolated policy violation.

15. The method of claim 14, wherein the secondary source is a second node of the plurality of nodes.

16. The method of claim 11, wherein obtaining the policy violation notification comprises identifying a flag setting provided by the monitoring agent.

17. The method of claim 11, wherein the metric is one of Xid diagnostic data for the node or a characteristic of the node.

18. The method of claim 11, wherein each of the plurality of nodes is one of a physical machine, virtual machine, or a container.

19. A controller comprising:
one or more processors configured to execute instructions, the instructions causing the controller to:
determine a policy for a metric of a node of a plurality of nodes, the policy comprising a metric identifier associated with the metric and a policy violation criterion associated with the metric, wherein the metric is associated with a monitoring agent of a plurality of monitoring agents;
upon the metric satisfying the policy violation criterion, obtain a policy violation notification from the monitoring agent; and
in response to determining that the node is unreliable based on at least the policy violation notification, prevent the node from receiving a task processing assignment.

20. The controller of claim 19, wherein the instructions further causes the controller to:
upon obtaining the policy violation notification from the monitoring agent, determine, based on secondary metric data from a secondary source, whether the policy violation notification indicates a node health problem or an isolated policy violation.
